(19) United States
(12) Patent Application Publication
(10) Pub. No.: US 2013/0073182 A1
(43) Pub. Date: Mar. 21, 2013

(54) METHOD AND SYSTEM FOR IMPROVING FUEL ECONOMY AND CONTROLLING ENGINE EMISSIONS

(71) Applicants: Andrew Harland Lindsay, Georgetown (CA); Kevin Michael Dagenais, Mississauga (CA); Frank Jose Revoredo, Toronto (CA)

(72) Inventors: Andrew Harland Lindsay, Georgetown (CA); Kevin Michael Dagenais, Mississauga (CA); Frank Jose Revoredo, Toronto (CA)

(73) Assignee: 663447 N.B. INC., Mississauga, ON (CA)

(21) Appl. No.: 13/701,061

(22) PCT Filed: May 31, 2010
(86) PCT No.: PCT/CA2010/000831

§ 371 Date: Nov. 30, 2012

(51) Int. Cl. F02D 41/30

(52) U.S. Cl. CPC F02D 41/3005
USPC 701/103

(57) ABSTRACT

An engine controller for an engine configured for improving fuel economy and decreasing negative emission characteristics. The engine controller is operatively coupled to the engine and configured to intercept angular position sensor signals and generate an adjustable angular position sensor signal and output the adjusted signal to the engine control module operatively coupled to the engine. The engine control module is configured to control the fuel injector for the engine and is responsive to the adjusted angular position sensor signal. The engine controller is operatively coupled to a hydrogen injection module configured to deliver hydrogen to the engine in conjunction with the operation of the engine controller. According to another aspect, the engine controller is configured to intercept valve actuator signals from the engine control module intended to control variable valve actuators in the engine. The engine controller includes a module configured to adjust or modify the valve actuator signals in response to changes in the angular position of the engine and output the adjusted valve actuator signals to control the variable valve actuators in the engine.

### FIELD OF THE INVENTION

The present invention relates to internal combustion engines, and more particularly, to a method and system for improving fuel economy and controlling emissions in an engine or motor.

### BACKGROUND OF THE INVENTION

The adjustment of fuel injection timing is a common technique used to tune engines for fuel economy, horse power or to adjust emission characteristics. However, the improvements in fuel economy are often accompanied by degraded emission characteristics, which tends to negate the desirability of using such techniques.

Accordingly, there remains a need for improvements in the art.

### BRIEF SUMMARY OF THE INVENTION

The present invention comprises embodiments of a method and system for improving fuel economy in an engine or motor and improving emissions produced by the engine.

According to an embodiment, the present invention provides an engine integration controller suitable for use with an internal combustion engine.

According to another embodiment, the present invention provides a method for improving the fuel economy of an engine and reducing undesirable emission characteristics of the engine.

According to another embodiment, the present invention provides a circuit for conditioning and converting analog output signals generated by sensors for an engine.

In one aspect, the present invention comprises an engine controller for use with an engine, the engine controller comprises: an input port for receiving an angular position sensor signal from the engine; a module configured for adjusting the angular position sensor signal to generate an adjusted angular position sensor signal; an output port configured for outputting the adjusted angular position sensor signal to an engine control module operatively coupled to the engine and configured to control the engine; and a hydrogen control module configured for controlling injection of a hydrogen gas into the engine.

In another aspect, the present invention comprises a method for improving fuel economy in an engine, the engine including an engine control module operatively configured to control a fuel injector for the engine, the method comprises the steps of: determining an angular position for the engine based on an angular position sensor signal; adjusting the angular position sensor signal and applying the adjusted angular position sensor signal to the engine control module, and the engine control module being responsive to the adjusted position sensor signal to control the fuel injector so that fuel economy is improved; delivering a hydrogen gas to the engine in conjunction with the control of the fuel injector, so that any negative emission characteristics of the engine arising from the operation of the fuel injector are decreased.

In a further aspect, the present invention comprises a circuit for processing analog signal outputs from an engine, the circuit comprises: a differential input port, a first stage coupled to the differential input port and configured to remove any DC offset in the analog signal; a second stage coupled to the output of the first stage and configured to provide a high impedance signal reference; and an output stage coupled to the output of the second stage and configured to convert the coupled analog signal into one or more logic signals; and an output port coupled to the output of the output stage and configured to output the one or more logic signals.

In another aspect, the present invention comprises an engine controller for use with an engine, the engine controller comprises: an input port for receiving an angular position sensor signal from the engine; a module configured to determine a characterized angular position sensor signal and generate an adjusted angular position sensor signal based on the characterized angular position sensor signal, and the adjusted angular position sensor signal being adjustable with an advancement amount or a delay amount; an output port configured for outputting the adjusted angular position sensor signal to an engine control module operatively coupled to the engine and configured to control the engine; and a hydrogen control module configured for controlling injection of a hydrogen gas into the engine.

In yet another aspect, the present invention comprises method for improving fuel economy in an engine, the engine including an engine control module operatively configured to control a fuel injector for the engine, the method comprises the steps of: determining an angular position sensor signal corresponding to one or more angular positions of the engine; characterizing the angular position sensor signal and generating an adjusted angular position sensor signal and the adjusted angular position sensor signal being advanced or delayed in relation to the angular position sensor signal, and applying the adjusted angular position to the engine control module, and the engine control module being responsive to the adjusted position sensor signal to control the fuel injector so that fuel economy is improved; delivering a hydrogen gas to the engine in conjunction with the control of the fuel injector, so that any negative emission characteristics of the engine arising from the operation of the fuel injector are decreased.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present application, and in which:

FIG. 1 shows in block diagram form a fuel economy and emission control system according to an embodiment of the present invention;

FIG. 2 is a flowchart depicting the processing steps embodied in a method for improving fuel economy and improving emissions according to an embodiment of the present invention;

FIG. 3 is a schematic diagram of an input circuit for converting/conditioning output signals from sensors for the engine; and

FIG. 4 is a timing diagram showing exemplary camshaft and crankshaft signals.

Like reference numerals indicate like or corresponding elements in the drawings.

### DETAILED DESCRIPTION OF THE EMBODIMENTS

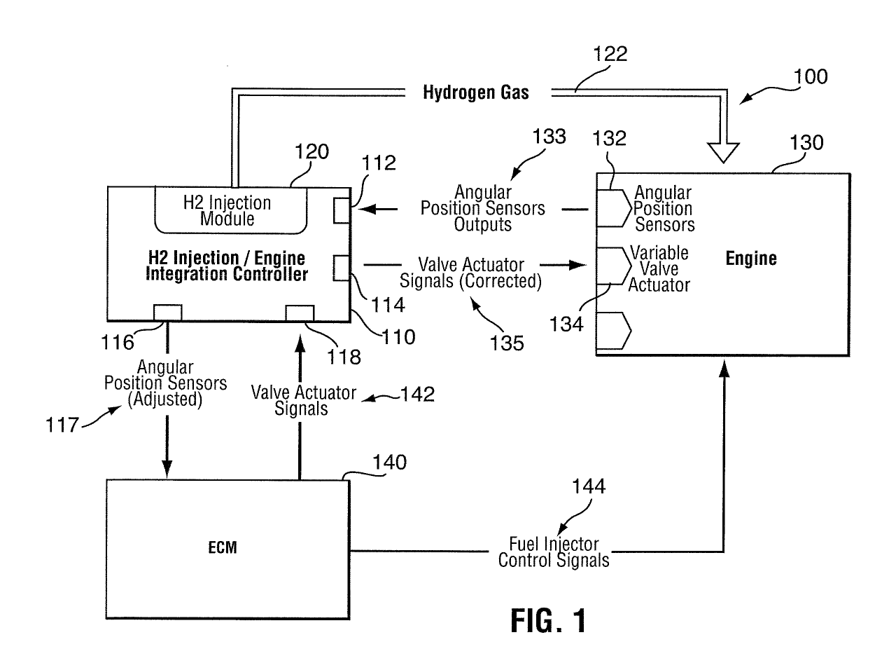

Reference is first made to FIG. 1, which shows a system for improving fuel economy and controlling engine emissions according to an embodiment of the invention and indicated generally by reference. The system 100 according to an embodiment comprises an engine integration controller 110 and a hydrogen injection module 120. As shown in FIG. 1, the engine integration controller 110 interfaces with an engine or motor 130 and an engine control module or ECM indicated by reference 140.

According to an exemplary implementation, the engine 130 is configured with angular position sensors and variable valve actuators. The angular position sensors indicated generally by reference 132 comprise sensors, for example, proximity sensors, that are configured to determine the angular position of the engine by detecting or sensing teeth or other indicia in the engine camshaft and/or engine crankshaft. The angular position sensors 132 generate angular position sensor output signals 133 that are utilized by the engine integration controller 110 to generate adjusted angular position sensor output signals 117 for the engine control module 140, as described in more detail below. The variable valve actuators (i.e. VVA) indicated generally by reference 134 comprise a mechanism for altering valve lift or duration in the engine 130 as will be within the understanding of those skilled in the art. The variable valve actuators 134 can be controlled, for example, by the engine control module 140, as part of an emission control strategy. According to this aspect, the engine control module 140 generates valve actuator control signals 142 that are intended for the variable valve actuators 134. The valve actuator control signals 142 are intercepted by the engine integration controller 110 and provide the basis for the generation of corrected or otherwise modified valve actuator signals 135 that are then applied to the variable valve actuator 134, as will be described in more detail below.

The hydrogen injection module 120 is configured to deliver hydrogen (and oxygen gas) 122 to the air intake manifold of the engine 130. According to an exemplary implementation, the engine comprises a turbo-charger equipped engine and is operable in a turbo-charged mode. The addition of hydrogen gas 122 to the combustion process of the engine 130 improves the quality of engine emissions by reducing nitrogen oxide, HC or un-combusted hydrocarbons, and particulate matter. According to an exemplary implementation, the hydrogen injection module 120 is based on the hydrogen electrolyser available from Hy-Drive Technologies Ltd. of Mississauga, Ontario, Canada. The hydrogen electrolyser technology from Hy-Drive Technologies is further described in published Canadian Patent Application No. 2,534,454, which is hereby incorporated herein in its entirety by this reference. According to an embodiment, the hydrogen injection module 120 is configured to operate under the control of and in conjunction with the engine integration controller 110. According to one aspect, injection timing of the engine 130 is adjusted when hydrogen delivering is on-going, i.e. hydrogen is being injected into the intake manifold of the engine 130. In an exemplary implementation, hydrogen injection comprises generating hydrogen gas with a positive pressure that causes the gas to flow from the H2 injection module 120 toward the intake manifold of the engine 130. At the air intake manifold, the intake air stream carries the hydrogen gas into the engine 130.

Referring again to FIG. 1, the engine integration controller 110 includes a port 112 for receiving one or more angular position readings or signals from the angular position sensors 132 for the engine 130, and a port 114 for outputting or transmitting adjusted (or corrected) valve actuator signals 135 to the engine 130. As shown, the engine integration controller 110 includes a port 118 for inputting (i.e. intercepting) the valve actuator control signals 142 generated by the engine control module 140 and intended for the variable valve actuator 134 in the engine 130. As also shown in FIG. 1, the engine integration controller 110 also includes a port 116 for outputting adjusted angular position sensor output signals 117 to the engine control module 140. As will be described in more detail below, the engine integration controller 110 is configured (for example, using stored program control, computer or microprocessor executable instructions in firmware or software) to improve fuel economy of the engine 130 by adjusting or varying the fuel injector timing for the engine 130 and also to control the injection or addition of hydrogen to the engine's combustion process using the hydrogen injection module 120 in order to decrease or limit undesirable emission characteristics of the engine 130. In addition to a microprocessor or microcontroller operating under stored program control, the engine integration module 110 can be configured or include digital logic, analog circuits, sensors, transducers and other electronic or electrical hardware appropriately configured to provide the functionality as described herein.

According to one aspect, the engine integration controller 110 includes an angular position processor module or executable code component configured for receiving and processing the angular position sensor output signals 133 received from the engine 130 (i.e. via the input port 112) and generate the adjusted angular position sensor output signals 117. The adjusted angular position signals 117 are utilized by the engine control module 140 according to predetermined algorithms or control processes to generate fuel injector control signals 144 that control operation of the engine 130 for improved fuel efficiency. The operation and control of the fuel injector control signals 144 will be within the understanding of one skilled in the art. The angular position processor or module in the engine integration controller 110 may be implemented, for example, as an executable code or software component. According to one aspect, the angular position processor is configured to determine the angular position of the engine 130 by sensing the position of the engine camshaft and/or crankshaft. The camshaft and the crankshaft are typically constructed with gear teeth or other similar indicators that can be detected by a suitably positioned sensor (i.e. the angular position sensors 132) as the engine rotates. The gear teeth typically include uniquely identifiable sections, for example, one or more teeth having a different size, in order to identify a specific angular position of the engine. According to one aspect, the angular position processor module is configured to intercept the angular position sensor output signals 133, i.e. at the input port 112 on the engine integration controller 110, and adjust these signals, by advancing or retarding their timing, in order to achieve the desired fuel efficiency. The adjusted angular position sensor output signals 117 are then outputted to the engine control module 140. The engine control module 140 utilizes the adjusted angular position sensor signals 117 as if they were received directly from the angular position sensors 132, and operating under stored program control generates corresponding fuel injector control signals which control the engine 130 and thereby achieve the desired fuel efficiency parameters. It will be appreciated that this configuration as shown in FIG. 1 does not require the direct control or adjustment of the fuel injector control signals and thereby does not require extensive modification of the engine control module 140 and facilitates retrofit or after market installation of the engine integration controller 110 and/or the hydrogen injection module 120. According to another aspect, the engine integration controller 110 includes a hydrogen injection process controller or module which is configured to control the H2 injection module 120 and thereby the injection or addition of the hydrogen gas (and oxygen gas) 122 into the engine's air intake manifold in order to improve engine emission quality. It will be appreciated that the adjustment of the fuel injection control signals can result in certain undesirable emission characteristics, such as increased NOx and particulate matter or opacity. By controlling and adjusting both the angular position sensor output signals 133 and the injection of hydrogen gas into the air intake manifold of the engine 130, better fuel economy can be achieved without realizing the typical undesirable emissions.

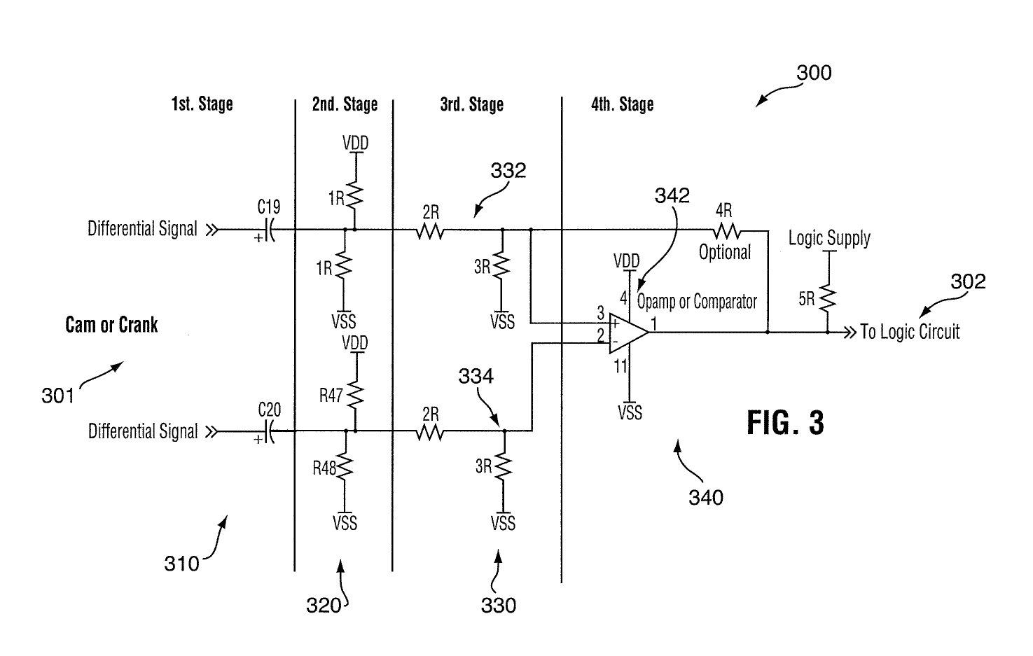

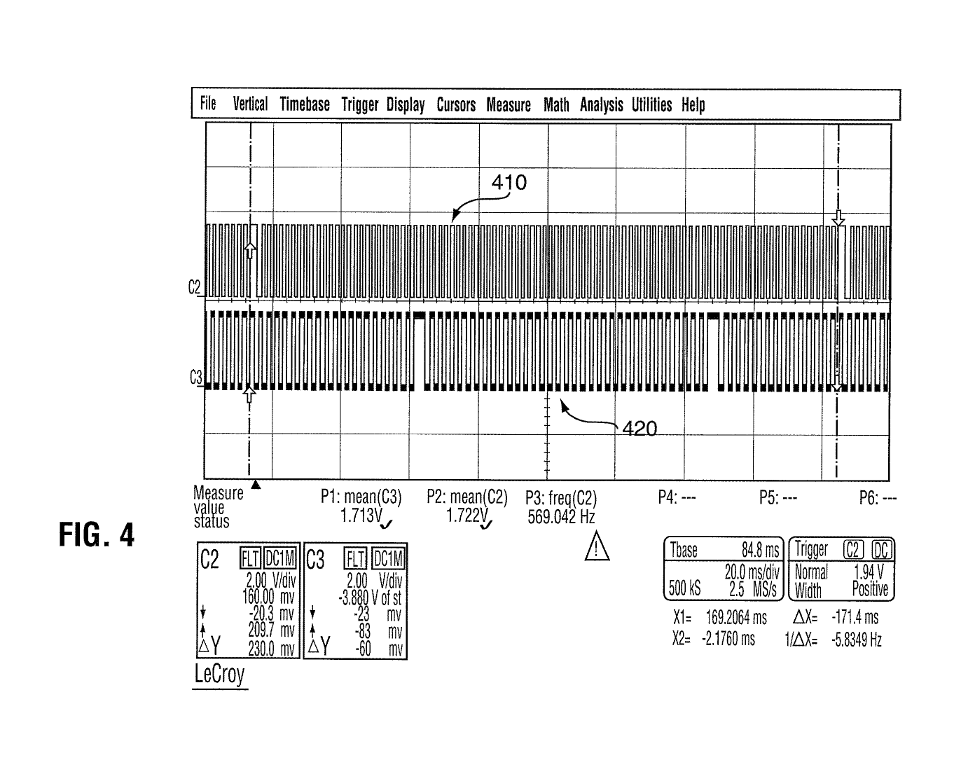

It will be appreciated that the characteristics of the angular position sensor output signals 133 can vary across engine manufacturers and/or engine models. This is not typically an issue for generating adjusted angular position sensor output signals that are retarded or delayed in time. It can, however, become a factor for generating adjusted angular position sensor output signals that are advanced in time. In order advance a signal, its future values need to be known and this means characterizing or generating a predictable signal. According to this aspect, the engine integration module 110 is configured with a module or code component to characterize a bi-level cyclical signal corresponding to the angular position of the engine 130 (i.e. based on the camshaft and/or crankshaft). According to an embodiment, the bi-level cyclical signal is generated as follows: the crankshaft is characterized as rotating once for each revolution of the engine and the camshaft is characterized as completing one full revolution for every two revolutions of the crankshaft (i.e. the engine); a set of synchronization teeth, or other similar indicia, on the crankshaft tone ring and/or the camshaft tone ring are utilized to identify the angular position of the engine; the cyclical pattern is then determined by identifying a repeating pattern (e.g. the shortest repeating pattern) of camshaft teeth that can be matched to two repeating patterns of crank teeth, which correspond to 720 degrees of revolution of the engine; once the bi-level signal is characterized, advancement of the angular position signal can be determined. According to an embodiment, the angular position sensor output signals, which are analog signals, are treated as a series of pulses having logical high and low values that span a given number of degrees of revolution. The module is configured to predict future values of the angular position sensor output signals from the engine based on the signal history. To advance the angular position signal, the module is configured to compute or calculate the amount of time represented by the desired shift in degrees based on the history of the input signal. Each rising and falling edge of the angular position sensor input signal will then appear on the adjusted angular position output signal an amount of time corresponding to the advance in timing. Reference is made to FIG. 4, which shows an exemplary timing diagram for CAT™ C15 truck engine. The timing diagram comprises an output signal for the cam shaft denoted by reference 410 and an output signal for the crankshaft denoted by reference 420. According to this example, the camshaft output signal 410 comprises 95 pulses for 720 degrees of revolution, and the crankshaft output signal 420 comprises 35 pulses signifying 360 degrees of revolution. According to another aspect, the camshaft 410 and crankshaft 420 output signals, i.e. pulse trains, are generated using a circuit as described below with reference to FIG. 3.

Referring to FIG. 1, the valve actuator signals 142 are used by the engine control module 140 to control the variable valve actuators 134 in the engine 130. Variable valve actuation comprises a mechanism for altering engine valve lift or duration, and is used as part of an emission control process for an engine. In a typical implementation, the engine control module 140 controls the variable valve actuator(s) 134 through the valve actuator signals 142 in a manner that will be understood by one skilled in the art. In the context of the present invention, the angular position sensor output signals 133 are modified by the engine integration module 110 and applied to the engine control module 140 in the form of the adjusted angular position sensor signals 117. It will be appreciated that tasks or processes in the engine control module 140 that rely on the angular position of the engine will be affected by the adjusted angular position sensor signals 117. To account for this effect, the engine integration module 110 is configured with a module or code component for processing the valve actuator signals 142 generated by the engine control module 140. According to an embodiment, the engine integration module 110 intercepts or inputs the valve actuator signals 142 generated by the engine control module 140 (and intended for the variable valve actuator 134) at the port 118, and the valve actuator module in the engine integration module 110 is configured to generate corrected valve actuator signals 135 based on the original valve actuator signals 142. According to an embodiment, the corrected valve actuator signals 135 comprise valve actuator signals 142 that have been delayed or retarded by an amount corresponding to the advancement of the angular position sensor signals 117.

Another mechanism that can be affected by the angular position of the engine 130 is engine braking. For the engine braking mechanism, the engine 130 includes one or more solenoids or similar actuators (for example, the variable valve actuators 134) that are configured to actuate the engine valves, for example, under the control of the engine control module 140. To brake the engine, the valves are controlled to produce pressure changes in the engine cylinders that slow the speed of engine, and thereby the drive train (and wheels) coupled to the crankshaft of the engine 130. The operation of the engine braking mechanism is thereby affected by adjustments to the actuation of the engine valves, for instance, in response to the adjusted angular position sensor output signals 117 processed by the engine control module 140. In order to account for this potential undesirable effect on engine braking, the engine integration module 110 includes an engine braking module or code component that intercepts the engine braking signals and adjusts them according to the advancement of the angular position sensor signals 117. According to an embodiment, the engine braking control signals comprise a subset of the variable valve actuator signals 142 generated by the engine control module 140, and are intercepted by the engine integration module 110 at input port 118 and modified to generate the corrected valve actuator signals 135 that are outputted at the port 114 and applied to the variable valve actuators 134 in the engine 130. According to another aspect, the variable valve actuators 134 can also be controlled to increase or improve engine efficiency by operating the engine 130 in a “Miller cycle”. Accordingly, variations in the angular position of engine can affect the operation of the variable valve actuators 134 and adjustments may be required as will be within the understanding of one skilled in the art.

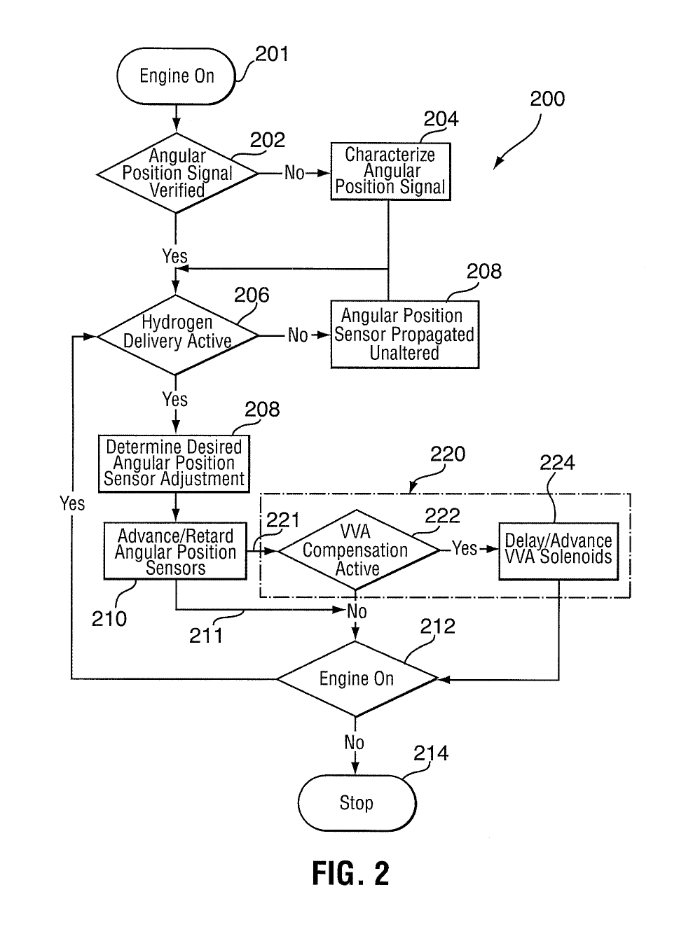

Reference is next made to FIG. 2, which shows in flowchart a process and method steps for controlling an engine in accordance with an embodiment according to the present invention. The process is indicated generally by reference 200 and according to an exemplary implementation the functionality is embodied in software or firmware that is executed by one or more modules or code components in the engine integration module 110 and the hydrogen injection module 120 operating under stored program control or a combination of programmable devices and logic devices or circuits. The particular implementation and coding details will be within the understanding of one skilled in the art.

As shown in FIG. 2, the process 200 is operated or invoked when the engine is turned on or is running (block 201). The first step in the control process 200 comprises verifying an angular position signal as indicated by decision block 202. If there is no angular position signal or valid angular position signal, then control process 200 characterizes an angular position signal for the engine as indicated by block 204. The angular position signal is determined for example as described above. If the angular position signal is verified (decision block 202) or the angular position signal has been characterized (block 204), then the next processing step in the process 200 comprises determining if the hydrogen delivery system (e.g. the hydrogen injection module 120 in FIG. 1) is active, as indicated by decision block 206. According to an embodiment, if the hydrogen delivery system is not active (as determined in decision block 206), then the angular position signals are propagated without any adjustment or modification as indicated by block 208, i.e. the angular position sensor output signals 133 (FIG. 1) received from the engine 130 are passed directly to the engine control module 140 (FIG. 1) as the angular position sensor signals 117. The control process 200 then loops back to the hydrogen delivery active decision block 206 and repeats. If the hydrogen delivery module or subsystem is active, then according to an embodiment, the angular position sensor output signals are adjusted by the engine integration controller to improve the fuel economy of the engine. As shown in block 208, the control process 200 is configured to determine a desired or target angular position sensor adjustment. The adjustment amount can be based on a number of factors, such as, the level of fuel economy improvement desired, the current or future hydrogen injection amounts, the type or model of engine, the speed of the engine and other related engine operating parameters, such as engine speed and boost pressure (i.e. manifold air pressure). Based on the adjustment amount determined in block 208, the angular position sensor output signals are adjusted and output to the engine control module, for example, as described above with reference to FIG. 1. As indicated in block 210, the engine control module, in turn, advances or retards the angular position sensors based on the adjusted signals generated and received from the engine integration controller. The control process 200 then proceeds to decision block 212 as indicated by reference 211 to check if the engine is on. If the engine is on, then the control process 206 proceeds to decision block 206 and the control/processing steps are repeated as described above. If the engine is no longer on, as determined in decision block 212, then the control process 200 is terminated or stops as indicated by block 214.

According to another embodiment, the control process 200 is configured for a variable valve actuator compensation process indicated generally by reference 220, for example, as described above for emission control and/or engine braking. According to this embodiment and as shown in FIG. 2, the adjustment of the angular position sensors in block 210 is followed by branching 221 to decision block 222. In decision block 222, the control process 200 is configured to determine if the variable valve actuator compensation process is active or has been activated. If active, then the control process 200 is configured as indicated in block 224 to delay or advance the variable valve actuators or solenoids, for example, with the engine integration module 110 (FIG. 1) generating the adjusted or modified valve actuator signals 135 (FIG. 1) and applying these signals to the variable valve actuators 134 (FIG. 1) in the engine 130, for example, as described above. The control process 200 then checks if the engine is on in decision block 212 and continues the process at block 206 or stops at block 214 as described above.

Reference is next made to FIG. 3, which shows in schematic form a differential input circuit according to an embodiment of the present invention and indicated generally by reference 300. It will be appreciated that the output signals derived from the camshaft and crankshaft transducers can vary from engine to engine. In addition, ground references can vary with respect to the engine chassis or battery negative. As will be described in more detail below, the input circuit 300 is configured to convert or condition the analog output signals from the engine, e.g. the angular position sensor output signals 133 and/or the valve actuator signals 142, for further processing by the engine integration controller 110. According to an aspect, the differential input circuit 300 converts the variable engine output signals into a logic level independent of amplitude of the originating signal and/or the ground reference.

As shown in FIG. 3, the differential input circuit 300 comprises an input port 301, a first stage 310, a second stage 320, a third stage 330, a fourth or output stage 340 and an output port 302. The input port 301 comprises a differential input port with positive and negative terminals. The first stage 310 capacitively couples the input signal to eliminate any DC offset and comprises a first capacitor C19 coupled to the positive input terminal and a second capacitor C20 coupled to the negative input terminal for the input port 301. The second stage 320 provides a high impedance reference to circuit ground, i.e. VSS, which may be connected to circuit ground or a negative power supply terminal. The second stage 320 is configured with resistors as shown in FIG. 3. The third stage 330 comprises resistors 2R and 3R which are configured as two respective voltage dividers 332 and 334, and provided where high input voltage levels are expected or may be present. The fourth stage 340 comprises a comparator, or an operational amplifier, indicated by reference 342. The differential output from the third stage 330 is applied to the inputs of the comparator 342, and the comparator 342 is configured to produce a TTI, logic level output signal at the output port 302. The operational amplifier 342 can be configured in known manner using resistor 4R to adjust the gain and provide another output logic level. For a comparator implementation, the resistor 4R is configured to provide hysteris for the comparator 342. The output port 302 is coupled to logic circuit(s) in the engine integration controller 110 (FIG. 1) and then subjected to further processing, for example, under stored program control as described above. As shown, a pull-up resistor 5R is provided for comparator devices with an open collector output. To adjust the hysteresis of the comparator, the resistor 4R can be used.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. An engine controller for use with an engine, said engine controller comprising:
an input port for receiving an angular position sensor signal from the engine;
a module configured for adjusting said angular position sensor signal to generate an adjusted angular position sensor signal; and
an output port configured for outputting said adjusted angular position sensor signal to an engine control module operatively coupled to the engine and configured to control the engine.

2. The engine controller as claimed in claim 1, wherein said module is configured to determine a characterized angular position sensor signal and said adjusted angular position sensor signal being generated from said characterized angular position sensor signal and being adjustable with an advancement amount or a delay amount.

3. The engine controller as claimed in claim 2, wherein said characterized angular position sensor signal is based on indicia indicative of the angular position of the engine, and said indicia including one or more of camshaft position and crankshaft position.

4. The engine controller as claimed in claim 1, further including an input port operatively coupled to the engine control module for intercepting a variable valve actuator generated by the engine control module, and a variable valve signal adjustment module configured for adjusting the variable valve actuator signal and transmitting said adjusted variable valve actuator signal to the engine on an output port operatively to the engine.

5. The engine controller as claimed in claim 4, wherein said variable valve signal adjustment module is configured to adjust the variable valve actuator signal in response to changes in the angular position sensor signal.

6. A method for improving fuel economy in an engine, the engine including an engine control module operatively configured to control a fuel injector for the engine, said method comprising:
determining an angular position for the engine based on an angular position sensor signal; and
adjusting said angular position sensor signal and applying said adjusted angular position sensor signal to the engine control module, and said engine control module being responsive to said adjusted position sensor signal to control the fuel injector.

7. The method as claimed in claim 6, further including inputting a valve actuator signal generated by the engine control module, and generating a modified valve actuator signal and outputting said modified valve actuator signal to the engine, and said modified valve actuator signal being adjustable according to changes in said angular position sensor signal.

8. The method as claimed in claim 6, wherein determining an angular position for the engine comprises characterizing said angular position sensor signal, and said characterized angular position sensor signal providing predictive values for advancing said angular position sensor signal and for retarding said angular position sensor signal to generate said adjusted angular position sensor signal.

9. The method as claimed in claim 8, further including inputting a valve actuator signal generated by the engine control module, and generating a modified valve actuator signal and outputting said modified valve actuator signal to the engine, and said modified valve actuator signal being adjustable according to changes in said angular position sensor signal.

10. The method as claimed in claim 9, wherein said modified valve actuator signal is delayed when said angular position sensor signal is advanced.

11. A circuit for processing analog signal outputs from an engine, said circuit comprising:
a differential input port,
a first stage coupled to said differential input port and configured to remove any DC offset in the analog signal;
a second stage coupled to the output of said first stage and configured to provide a high impedance signal reference; and
an output stage coupled to the output of said second stage and configured to convert the coupled analog signal into one or more logic signals; and
an output port coupled to the output of said output stage and configured to output said one or more logic signals.

12. The circuit as claimed in claim 11, further including a voltage divider stage, said voltage divider stage being coupled between the output of said second stage and the input of said output stage, and comprising a voltage divider for the positive terminal of said differential input port and another voltage divider for the negative terminal of said differential input port.

13. The circuit as claimed in claim 11, wherein said analog signal output comprises an angular position sensor signal, said angular position sensor signal being indicative of the angular position of the engine.

14. An engine controller for use with an engine, said engine controller comprising:
an input port for receiving an angular position sensor signal from the engine;
a module configured to determine a characterized angular position sensor signal and generate an adjusted angular position sensor signal based on said characterized angular position sensor signal, and said adjusted angular position sensor signal being adjustable with an advancement amount or a delay amount; and
an output port configured for outputting said adjusted angular position sensor signal to an engine control module operatively coupled to the engine and configured to control the engine.

15. The engine controller as claimed in claim 14, wherein said characterized angular position sensor signal is based on indicia indicative of the angular position of the engine, and said indicia including one or more of camshaft position and crankshaft position.

16. The engine controller as claimed in claim 14, further including an input port operatively coupled to the engine control module for intercepting a variable valve actuator generated by the engine control module, and a variable valve signal adjustment module configured for adjusting the variable valve actuator signal and transmitting said adjusted variable valve actuator signal to the engine on an output port operatively to the engine.

17. The engine controller as claimed in claim 16, wherein said variable valve signal adjustment module is configured to adjust the variable valve actuator signal in response to changes in the angular position sensor signal.

18. A method for improving fuel economy in an engine, the engine including an engine control module operatively configured to control a fuel injector for the engine, said method comprising:
determining an angular position sensor signal corresponding to one or more angular positions of the engine; and
characterizing said angular position sensor signal and generating an adjusted angular position sensor signal and said adjusted angular position sensor signal being advanced or delayed in relation to said angular position sensor signal, and applying said adjusted angular position to the engine control module, and the engine control module being responsive to said adjusted position sensor signal to control the fuel injector.

19. The method as claimed in claim 18, further including inputting a valve actuator signal generated by the engine control module, and generating a modified valve actuator signal and outputting said modified valve actuator signal to the engine, and said modified valve actuator signal being adjustable according to changes in said angular position sensor signal.

20. The method as claimed in claim 19, further including inputting a valve actuator signal generated by the engine control module, and generating a modified valve actuator signal and outputting said modified valve actuator signal to the engine, and said modified valve actuator signal being adjustable according to changes in said angular position sensor signal.

21. (canceled)

22. The engine controller as claimed in claim 1, further comprising a hydrogen control module configured for controlling injection of a hydrogen gas into the engine.

23. The method as claimed in claim 6, further comprising delivering a hydrogen gas to the engine in conjunction with the control of the fuel injector.

24. The engine controller as claimed in claim 14, further comprising a hydrogen control module configured for controlling injection of a hydrogen gas into the engine.

25. The method as claimed in claim 18, further comprising delivering a hydrogen gas to the engine in conjunction with the control of the fuel injector.

26. The engine controller as claimed in claim 1, wherein when the engine controller is in use with the engine at least one of fuel economy of the engine is improved and emissions of the engine are reduced.

27. The method as claimed in claim 6, wherein at least one of fuel economy of the engine is improved and emissions of the engine are reduced.

28. The engine controller as claimed in claim 14, wherein when the engine controller is in use with the engine at least one of fuel economy of the engine is improved and emissions of the engine are reduced.

29. The method as claimed in claim 18, wherein at least one of fuel economy of the engine is improved and emissions of the engine are reduced.

30. The engine controller as claimed in claim 1, wherein when the engine controller is in use with the engine maintenance costs associated with the engine are reduced.

31. The method as claimed in claim 6, wherein maintenance costs associated with the engine are reduced.

32. The engine controller as claimed in claim 14, wherein when the engine controller is in use with the engine maintenance costs associated with the engine are reduced.

33. The method as claimed in claim 18, wherein maintenance costs associated with the engine are reduced.
